(19) United States
(12) Patent Application Publication
(10) Pub. No.: US 2011/0025697 A1
(43) Pub. Date: Feb. 3, 2011

(54) METHOD FOR TRANSMITTING IMAGE DATA THROUGH RSDS TRANSMISSION INTERFACES

(76) Inventors: Ying-Lieh Chen, Sinshih Township (TW); Wen-Teng Fan, Sinshih Township (TW); Chao-Ching Chi, Sinshih Township (TW)

Correspondence Address: HAYES SOLOWAY P.C., 3450 E. SUNRISE DRIVE, SUITE 140, TUCSON, AZ, 85718, US

(21) Appl. No.: 12/510,940

(22) Filed: Jul. 28, 2009

(51) Int. Cl. G06F 13/14

(52) U.S. Cl. 345/520; 345/204

(57) ABSTRACT

A method for transmitting image data through reduced swing differential signaling (RSDS) transmission interfaces to a driver in a display is provided, in which the image data include a number of pixel values each represented by a number of bits. The method includes the step of: simultaneously transmitting at least two bits of one of the pixel values by a single timing controller in one time period, in which each of the simultaneously transmitted bits is transmitted through a respective data line of the RSDS transmission interfaces.

### BACKGROUND

1. Field of Invention

The present invention relates to a method for transmitting image data. More particularly, the present invention relates to a method for transmitting image data through reduced swing differential signaling (RSDS) transmission interfaces to a driver in a display.

2. Description of Related Art

Reduced swing differential signaling (RSDS) is a differential interface with a nominal signal swing of 200 mV. RSDS defines the output characteristics of a transmitter and the inputs of a receiver along with the protocol for a chip-to-chip interface between timing controllers and drivers. RSDS also retains many benefits such as high noise immunity, high data rate, low EMI characteristics and low power dissipation.

The image data including a plurality of pixel values, each of which represented by a plurality of bits, is transmitted through the RSDS transmission interface from the timing controller to the driver in a display. However, with the display resolution getting higher, the frequency for image data transmission between the timing controller and the driver also gets higher, which causes EMI issues and power consumption.

### SUMMARY

In accordance with one embodiment of the present invention, a display is provided. The display includes a timing controller and a source driver. The timing controller includes a transmitter connected to a bus including a plurality of transmission lines each for sending a same number of pixel data. The source driver includes a receiver and plural channels, in which the receiver is connected to the bus to receive the pixel data sent through the bus, for reorganizing the pixel data to generate a new sequence of pixel data, based on a bus mode, for the channels.

In accordance with another embodiment of the present invention, a method for transmitting image data in a display is provided. The method includes the steps of: sending a same number of pixel data respectively through one of a plurality of transmission lines of a bus to a source driver; reorganizing the pixel data in the source driver; and generating a new sequence of pixel data according to the reorganization of the pixel data sent through the transmission lines, for channels in the source driver.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference to the accompanying drawings as follows:

FIG. 1 illustrates a general block diagram of a display according to one embodiment of the present invention;

FIG. 2A illustrates a timing diagram of data transmission in FIG. 1 according to a first embodiment of the present invention;

FIG. 2B illustrates a general timing diagram of data transmission and reorganization mentioned in FIG. 2A;

FIG. 2C illustrates a timing diagram of data transmission in FIG. 1 according to a second embodiment of the present invention;

FIG. 2D illustrates a general timing diagram of data transmission and reorganization mentioned in FIG. 2C;

FIG. 3A illustrates a timing diagram of data transmission in FIG. 1 according to a third embodiment of the present invention;

FIG. 3B illustrates a general timing diagram of data transmission and reorganization mentioned in FIG. 3A;

FIG. 3C illustrates a timing diagram of data transmission in FIG. 1 according to a fourth embodiment of the present invention; and

FIG. 3D illustrates a general timing diagram of data transmission and reorganization mentioned in FIG. 3C.

### DESCRIPTION OF THE PREFERRED EMBODIMENTS

In the following detailed description, the embodiments of the present invention have been shown and described. As will be realized, the invention is capable of modification in various respects, all without departing from the invention. Accordingly, the drawings and description are to be regarded as illustrative in nature, and not restrictive.

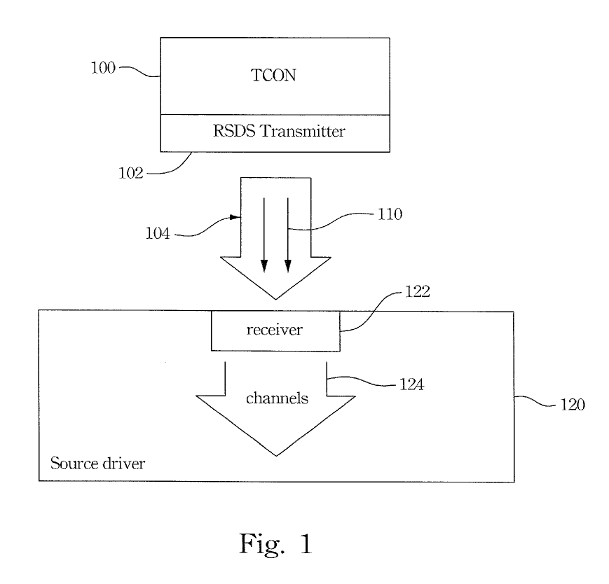

FIG. 1 illustrates a general block diagram of a display according to one embodiment of the present invention. The display includes a timing controller 100 and a source driver 120. The timing controller 100 includes a transmitter 102, which is for example a reduced swing differential signaling (RSDS) transmitter. The transmitter 102 is connected to a transmission bus 104, for sending pixel data through the transmission bus 104 to the source driver 120. The transmission bus 104 includes a plurality of buses 110 each respectively for sending pixel data.

The source driver 120 includes a receiver 122 and plural channels 124, in which the receiver 122 can be embodied as a line buffer. The receiver 122 is connected to the transmission bus 104 and receives the pixel data through the transmission bus 104. In other words, the receiver 122 receives the pixel data respectively from the buses 110.

Further, the receiver 122 reorganizes the pixel data to generate a new sequence of pixel data, based on a bus mode, for the channels 124. In one embodiment, the receiver 122 alternatively selects the pixel data sent by each of transmission lines 110 to be outputted as the new sequence of pixel data for the channels 124.

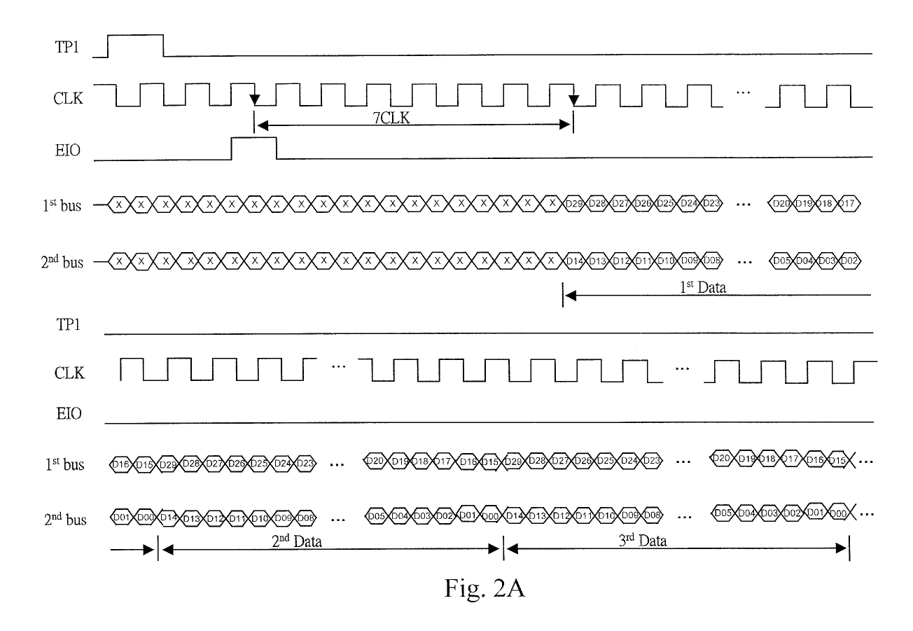

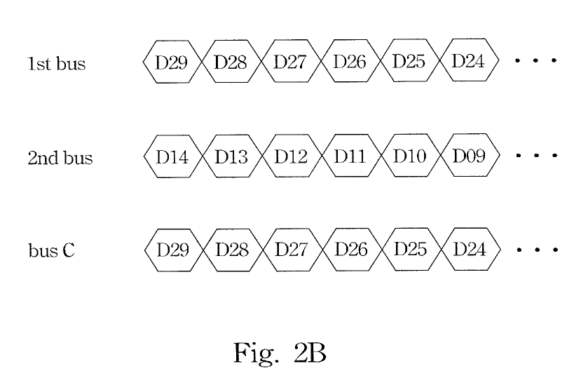

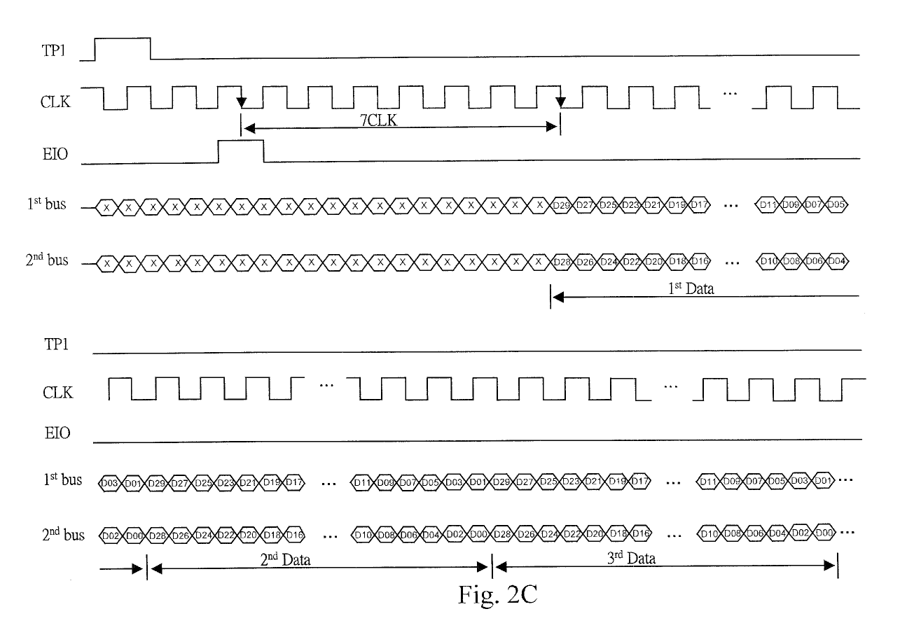

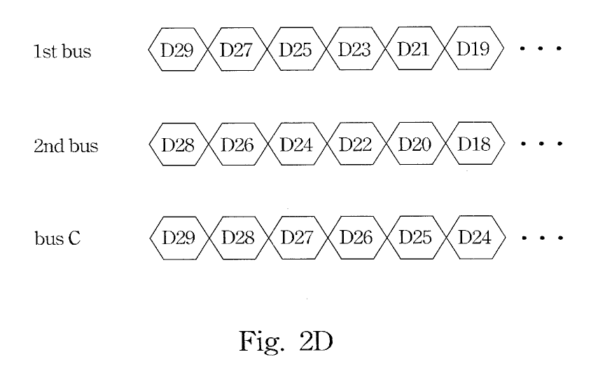

In one embodiment, the transmission bus 104 includes two buses 110 each respectively for sending pixel data. FIG. 2A illustrates a timing diagram of data transmission in FIG. 1 according to a first embodiment of the present invention. Hereinafter, 1^{st} bus 110 is provided for transmitting a first sequence of pixel data (e.g. D29, D28, D27, D26, . . . , D15) of 1^{st} image data from the timing controller 100, 2^{nd} bus 110 is provided for transmitting a second sequence of pixel data (e.g. D14, D13, D12, D11, . . . , D00) of 1^{st} image data from the timing controller 100. First, if an enable input/output signal (EIO) is activated, the first sequence of pixel data D29, D28, D27, D26, . . . , D15 and the second sequence of pixel data D14, D13, D12, D11, . . . , D00 are sent respectively from the 1^{st} bus 110 and the 2^{nd} bus 110 to the receiver 122 of the source driver 120. Then, the first sequence of pixel data D29, D28, D27, D26, . . . , D15 and the second sequence of pixel data D14, D13, D12, D11, . . . , D00 are reorganized by the receiver 122 of the source driver 120, and the new sequence of pixel data are generated according to the reorganization of the first sequence of pixel data D29, D28, D27, D26, . . . and the second sequence of pixel data D14, D13, D12, D11, . . . .

FIG. 2B illustrates a general timing diagram of data transmission and reorganization mentioned in FIG. 2A. As shown in FIG. 2B, after the first sequence of pixel data D29, D28, D27, D26, . . . , D15 and the second sequence of pixel data D14, D13, D12, D11, . . . , D00 are transmitted to and reorganized by the receiver 122, bus C representing the bus (not shown) for the receiver 122 transmits the new sequence of pixel data (e.g. D29, D28, D27, D26, . . . , D00) of 1^{st} image data to the channels 124.

In another embodiment, the receiver 122 alternatively selects the pixel data sent by the 1^{st} and 2^{nd} transmission lines to be outputted as the new sequence of pixel data for the channels 124. FIG. 2C illustrates a timing diagram of data transmission in FIG. 1 according to a second embodiment of the present invention. In present embodiment, 1^{st} bus is provided for transmitting a first sequence of pixel data (e.g. D29, D27, D25, D23, . . . , D01) of 1^{st} image data from the timing controller 100, 2^{nd} bus is provided for transmitting a second sequence of pixel data (e.g. D28, D26, D24, D22, . . . , D00) of 1^{st} image data from the timing controller 100. Similarly, if the enable input/output signal (EIO) is activated, the first sequence of pixel data D29, D27, D25, D23, . . . , D01 and the second sequence of pixel data D28, D26, D24, D22, . . . , D00 are sent respectively from the 1^{st} bus 110 and the 2^{nd} bus 110 to the receiver 122 of the source driver 120. Then, the first sequence of pixel data D29, D27, D25, D23, . . . , D01 and the second sequence of pixel data D28, D26, D24, D22, . . . , D00 are reorganized by the receiver 122 of the source driver 120, and the new sequence of pixel data are generated according to the reorganization of the first sequence of pixel data D29, D27, D25, D23, . . . , D01 and the second sequence of pixel data D28, D26, D24, D22, . . . , D00.

FIG. 2D illustrates a general timing diagram of data transmission and reorganization mentioned in FIG. 2C. As shown in FIG. 2D, after the first sequence of pixel data D29, D27, D25, D23, . . . , D01 and the second sequence of pixel data D28, D26, D24, D22, . . . , D00 are transmitted to and reorganized by the receiver 122, bus C representing the bus (not shown) for the receiver 122 transmits the new sequence of pixel data (e.g. D29, D28, D27, D26, . . . , D00) of 1^{st} image data to the channels 124.

Notably, in the embodiment of FIG. 2B or FIG. 2D, the timing controller 100 sends the pixel data through 1^{st} bus and 2^{nd} bus at a first clock rate, and the receiver 122 can output through bus C the new sequence of pixel data for the channels at a second clock rate twice the first clock rate.

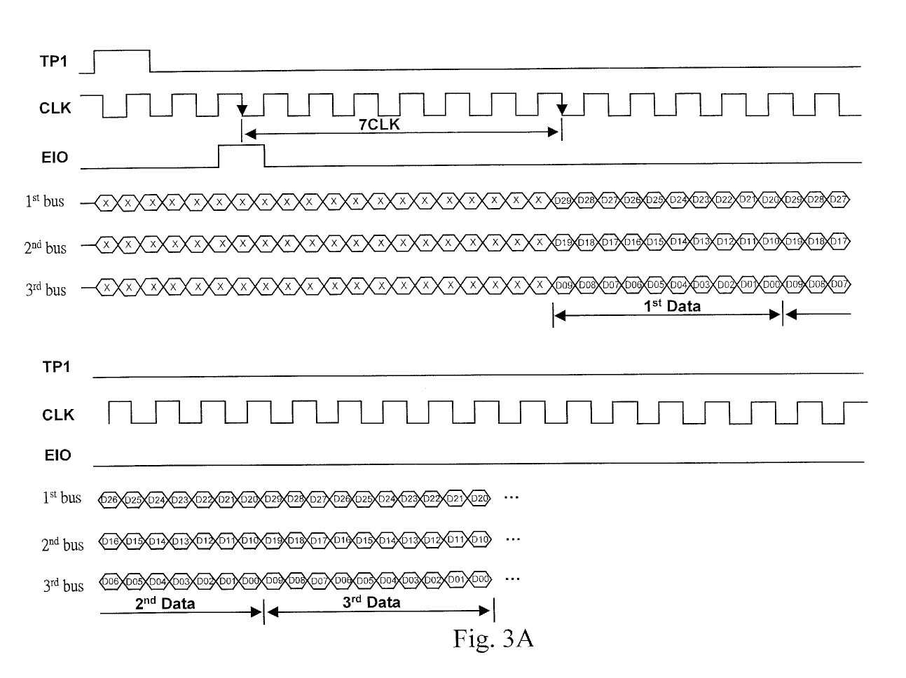

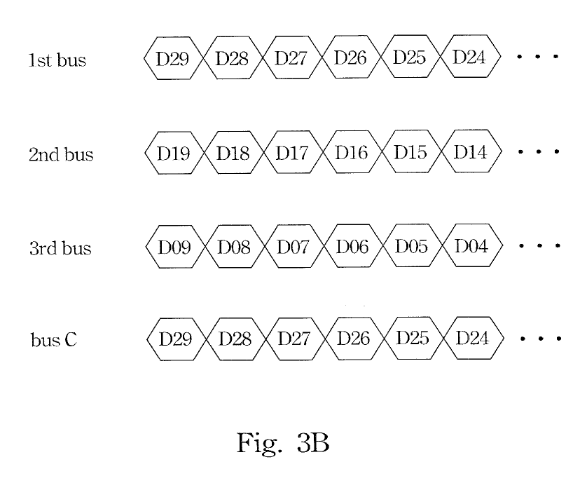

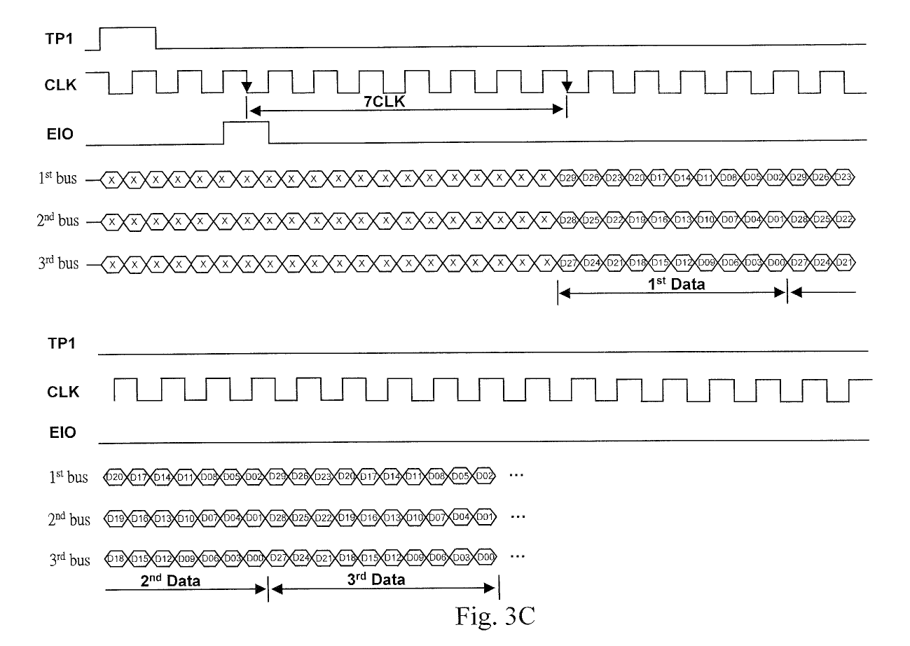

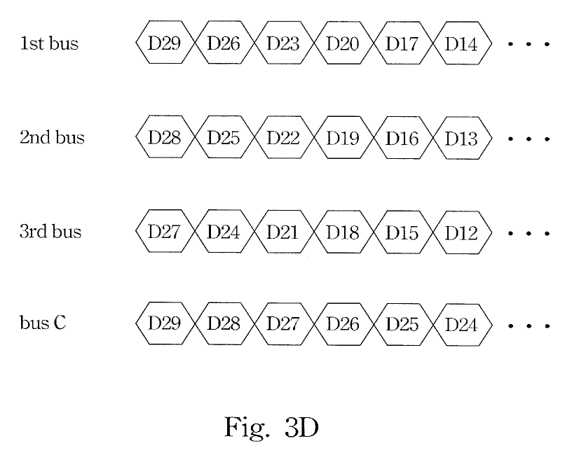

In another aspect, the transmission bus 104 includes three buses 110 each respectively for sending pixel data. FIG. 3A illustrates a timing diagram of data transmission in FIG. 1 according to a third embodiment of the present invention. Hereinafter, 1^{st} bus 110 is provided for transmitting a first sequence of pixel data (e.g. D29, D28, D27, D26, . . . , D20) from the timing controller 100, 2^{nd} bus 110 is provided for transmitting a second sequence of pixel data (e.g. D19, D18, D17, D16, . . . , D10) from the timing controller 100, 3^{rd} bus 110 is provided for transmitting a third sequence of pixel data (e.g. D09, D08, D07, D06, . . . , D00) from the timing controller 100. First, if an enable input/output signal (EIO) is activated, the first sequence of pixel data D29, D28, D27, D26, . . . , D20, the second sequence of pixel data D19, D18, D17, D16, . . . , D10 and the third sequence of pixel data D09, D08, D07, D06, . . . , D00 are sent respectively from the 1^{st} bus 110, the 2^{nd} bus 110 and the 3^{rd} bus 110 to the receiver 122 of the source driver 120. Then, the first sequence of pixel data D29, D28, D27, D26, . . . , D20 the second sequence of pixel data D19, D18, D17, D16, . . . , D10 and the third sequence of pixel data D09, D08, D07, D06, . . . , D00 are reorganized by the receiver 122 of the source driver 120, and the new sequence of pixel data are generated according to the reorganization of the first sequence of pixel data D29, D28, D27, D26, . . . , D20, the second sequence of pixel data D19, D18, D17, D16, . . . , D10 and the third sequence of pixel data D09, D08, D07, D06, . . . , D00.

FIG. 3B illustrates a general timing diagram of data transmission and reorganization mentioned in FIG. 3A. As shown in FIG. 3B, after first sequence of pixel data D29, D28, D27, D26, . . . , D20, the second sequence of pixel data D19, D18, D17, D16, . . . , D10 and the third sequence of pixel data D09, D08, D07, D06, . . . , D00 are transmitted to and reorganized by the receiver 122, bus C representing the bus (not shown) for the receiver 122 transmits the new sequence of pixel data (e.g. D29, D28, D27, D26, . . . , D00) of 1^{st} image data to the channels 124.

In another embodiment, the receiver 122 alternatively selects the pixel data sent by the 1^{st}, 2^{nd} and 3^{rd} bus 110 to be outputted as the new sequence of pixel data for the channels 124. FIG. 3C illustrates a timing diagram of data transmission in FIG. 1 according to a fourth embodiment of the present invention. In present embodiment, the 1^{st} bus 110 is provided for transmitting a first sequence of pixel data (e.g. D29, D26, D23, D20, . . . , D02) from the timing controller 100, the 2^{nd} bus 110 is provided for transmitting a second sequence of pixel data (e.g. D28, D25, D22, D19, . . . , D01) from the timing controller 100, the 3^{rd} bus 110 is provided for transmitting a third sequence of pixel data (e.g. D27, D24, D21, D18, . . . , D00) from the timing controller 100. Similarly, if the enable input/output signal (EIO) is activated, the first sequence of pixel data D29, D26, D23, D20, . . . , D02, the second sequence of pixel data D28, D25, D22, D19, . . . , D01, and the third sequence of pixel data D27, D24, D21, D18, . . . , D00 are sent respectively from the 1^{st} bus 110, the 2^{nd} bus 110 and the 3^{rd} bus 110 to the receiver 122 of the source driver 120. Then, the first sequence of pixel data D29, D26, D23, D20, . . . , D02, the second sequence of pixel data D28, D25, D22, D19, . . . , D01, and the third sequence of pixel data D27, D24, D21, D18, . . . , D00 are reorganized by the receiver 122 of the source driver 120, and the new sequence of pixel data D29, D28, D27, D26, . . . , D00 are generated accordingly.

FIG. 3D illustrates a general timing diagram of data transmission and reorganization mentioned in FIG. 3C. As shown in FIG. 3D, after the first sequence of pixel data D29, D26, D23, D20, . . . , D02, the second sequence of pixel data D28, D25, D22, D19, . . . , D01, and the third sequence of pixel data D27, D24, D21, D18, . . . , D00 are transmitted to and reorganized by the receiver 122, bus C representing the bus (not shown) for the receiver 122 transmits the new sequence of pixel data (e.g. D29, D28, D27, D26, . . . , D00) of 1^{st} image data to the channels 124.

Notably, in the embodiment of FIG. 3B or FIG. 3D, the timing controller 100 sends the pixel data through 1^{st}, 2^{nd} and 3^{rd} bus at a first clock rate, and the receiver 122 can output through bus C the new sequence of pixel data for the channels at a second clock rate tripling the first clock rate.

For the foregoing embodiment of the present invention, the method for transmitting the image data through the RSDS transmission interfaces can be provided to improve the efficiency and speed of the image data transmission, so as to further improve the operation speed of the display.

As is understood by a person skilled in the art, the foregoing embodiments of the present invention are illustrative of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A display, comprising:
a timing controller comprising a transmitter connected to a transmission bus comprising a plurality of buses each for sending pixel data; and
a source driver comprising a receiver and plural channels, the receiver being connected to the transmission bus to receive the pixel data sent through the transmission bus, for reorganizing the pixel data to generate a new sequence of pixel data, based on a bus mode, for the channels.

2. The display of claim 1, wherein the timing controller sends the pixel data at a first clock rate, and the receiver outputs the new sequence of pixel data at a second clock rate twice the first clock rate.

3. The display of claim 1, wherein the timing controller sends the pixel data at a first clock rate, and the receiver outputs the new sequence of pixel data at a second clock rate tripling the first clock rate.

4. The display of claim 1, wherein the buses comprises:
a first bus for sending a first sequence of pixel data; and
a second bus for sending a second sequence of pixel data,
wherein the first sequence of pixel data and the second sequence of pixel data are reorganized to be outputted as the new sequence of pixel data after sent to the receiver.

5. The display of claim 4, wherein the receiver alternatively selects one of the first sequence of pixel data and one of the second sequence of pixel data to be outputted as the new sequence of pixel data.

6. The display of claim 1, wherein the transmission lines comprises:
a first bus for sending a first sequence of pixel data;
a second bus for sending a second sequence of pixel data; and
a third bus for sending a third sequence of pixel data;
wherein the first sequence of pixel data, the second sequence of pixel data and the third sequence of pixel data are reorganized to be outputted as the new sequence of pixel data after sent to the receiver.

7. The display of claim 6, wherein the receiver alternatively selects one of the first sequence of pixel data, one of the second sequence of pixel data and one of the third sequence of pixel data to be outputted as the new sequence of pixel data.

8. The display of claim 1, wherein the receiver alternatively selects one of the pixel data sent by each of the buses to be outputted as the new sequence of pixel data.

9. The display of claim 1, wherein the transmitter is a reduced swing differential signaling (RSDS) transmitter.

10. A method for transmitting image data in a display, comprising the steps of:
sending a same number of pixel data respectively through one of a plurality of buses of a transmission bus to a source driver;
reorganizing the pixel data in the source driver; and
generating a new sequence of pixel data according to the reorganization of the pixel data sent through the buses, for channels in the source driver.

11. The method of claim 10, wherein the pixel data sent to the source driver are sent at a first clock rate, and the new sequence of pixel data are transmitted in the source driver at a second clock rate twice the first clock rate.

12. The method of claim 10, wherein the pixel data sent to the source driver are sent at a first clock rate, and the new sequence of pixel data are transmitted in the source driver at a second clock rate tripling the first clock rate.

13. The method of claim 10, wherein the step of sending the pixel data further comprises:
sending a first sequence of pixel data through a first bus of the buses; and
sending a second sequence of pixel data through a second bus of the buses such that the first sequence of pixel data and the second sequence of pixel data are to be reorganized.

14. The method of claim 13, wherein the step of reorganizing the pixel data further comprises:
alternatively selecting one of the first sequence of pixel data and one of the second sequence of pixel data to generate the new sequence of pixel data.

15. The method of claim 10, wherein the step of sending the pixel data further comprises:
sending a first sequence of pixel data through a first bus of the buses;
sending a second sequence of pixel data through a second bus of the buses such that the first sequence of pixel data, the second sequence of pixel data and the third sequence of pixel data are to be reorganized.

16. The method of claim 15, wherein the step of reorganizing the pixel data further comprises:
alternatively selecting one of the first sequence of pixel data, one of the second sequence of pixel data and one of the third sequence of pixel data to generate the new sequence of pixel data.

17. The method of claim 10, wherein the step of reorganizing the pixel data further comprises:
alternatively selecting each of the pixel data sent by one of the buses to generate the new sequence of pixel data.

18. The method of claim 10, wherein the pixel data are sent through a reduced swing differential signaling (RSDS) bus.
